(19) United States
(12) Patent Application Publication
(10) Pub. No.: US 2021/0150325 A1
(43) Pub. Date: May 20, 2021

(54) DATA PROCESSING METHOD AND APPARATUS, AND RELATED PRODUCT

(71) Applicant: CAMBRICON TECHNOLOGIES CORPORATION LIMITED, Beijing (CN)

(72) Inventors: Shaoli Liu, Beijing (CN); Bingrui WANG, Beijing (CN); Xiaoyong ZHOU, Beijing (CN); Yimin ZHUANG, Beijing (CN); Huiying LAN, Beijing (CN); Jun LIANG, Beijing (CN)

(73) Assignee: CAMBRICON TECHNOLOGIES CORPORATION LIMITED, Beijing (CN)

(21) Appl. No.: 17/137,245

(22) Filed: Dec. 29, 2020

Related U.S. Application Data
(63) Continuation of application No. PCT/CN2020/082775, filed on Apr. 1, 2020.

(30) Foreign Application Priority Data
Apr. 4, 2019 (CN) 201910272411.9

(51) Int. Cl. G06N 3/063; G06F 17/16; G06F 9/38; G06F 9/30

(52) U.S. Cl. CPC G06N 3/063; G06F 9/30192; G06F 9/3855; G06F 17/16

(57) ABSTRACT

The present disclosure provides a data processing method and an apparatus and related products. The products include a control module including an instruction caching unit, an instruction processing unit, and a storage queue unit. The instruction caching unit is configured to store computation instructions associated with an artificial neural network operation; the instruction processing unit is configured to parse the computation instructions to obtain a plurality of operation instructions; and the storage queue unit is configured to store an instruction queue, where the instruction queue includes a plurality of operation instructions or computation instructions to be executed in the sequence of the queue. By adopting the above-mentioned method, the present disclosure can improve the operation efficiency of related products when performing operations of a neural network model.

### CROSS-REFERENCE TO RELATED APPLICATIONS

This is a bypass continuation application of PCT Application No. PCT/CN2020/082775 filed Apr. 1, 2020, which claims benefit of priority to Chinese Application No. 201910272411.9 filed Apr. 4, 2019, Chinese Application No. 201910272625.6 filed Apr. 4, 2019, Chinese Application No. 201910320091.X filed Apr. 19, 2019, Chinese Application No. 201910340177.9 filed Apr. 25, 2019, Chinese Application No. 201910319165.8 filed Apr. 19, 2019, Chinese Application No. 201910272660.8 filed Apr. 4, 2019, and Chinese Application No. 201910341003.4 filed Apr. 25, 2019. The content of all these applications are incorporated herein in their entireties.

### TECHNICAL FIELD

The disclosure relates generally to the field of computer technologies, and more specifically to a data processing method and an apparatus and related products.

### BACKGROUND

With the continuous development of the AI (Artificial Intelligence) technology, it has gradually obtained wide application and worked well in the fields of image recognition, speech recognition, and natural language processing, and the like. However, as the complexity of AI algorithms is growing, the amount of data and data dimensions that need to be processed are increasing. In related arts, processors usually have to first determine data address based on parameters specified in data-read instructions, before reading the data from the data address. In order to generate the read and save instructions for the processor to access data, programmers need to set relevant parameters for data access (such as the relationship between different data, or between different dimensions of a data, etc.) when designing parameters. The above-mentioned method reduces the processing efficiency of the processors.

### SUMMARY

The present disclosure provides a data processing technical solution.

A first aspect of the present disclosure provides a data processing method including: determining that an operand of a first processing instruction includes an identifier of a descriptor, where content of the descriptor indicates a shape of tensor data on which the first processing instruction is to be executed; obtaining the content of the descriptor from a descriptor storage space according to the identifier of the descriptor; and executing the first processing instruction on the tensor data obtained according to the content of the descriptor.

A second aspect of the present disclosure provides a data processing apparatus including: a descriptor storage space and a control circuit configured to determine that an operand of a first processing instruction includes an identifier of the descriptor, where content of the descriptor indicates a shape of tensor data on which the first processing instruction is to be executed; and obtain the content of a descriptor from a descriptor storage space according to the identifier of the descriptor. The data processing apparatus further includes an executing circuit configured to execute the first processing instruction on the tensor data obtained according to the content of the descriptor.

A third aspect of the present disclosure provides a neural network chip including the data processing apparatus.

A fourth aspect of the present disclosure provides an electronic device including the neural network chip.

A fifth aspect of the present disclosure provides a board card including: a storage device, an interface apparatus, a control device, and the above-mentioned neural network chip. The neural network chip is connected to the storage device, the control device, and the interface apparatus respectively; the storage device is configured to store data; the interface apparatus is configured to implement data transmission between the neural network chip and an external device; and the control device is configured to monitor a state of the neural network chip.

According to embodiments of the present disclosure, by introducing a descriptor indicating the shape of a tensor, the corresponding content of the descriptor can be determined when the identifier of the descriptor is included in the operand of a decoded processing instruction, and the processing instruction can be executed according to the content of the descriptor, which can reduce the complexity of data access and improve the efficiency of data access.

In order to make other features and aspects of the present disclosure clearer, a detailed description of exemplary embodiments with reference to the drawings is provided below.

### BRIEF DESCRIPTION OF THE DRAWINGS

The accompanying drawings contained in and forming part of the specification together with the specification show exemplary embodiments, features and aspects of the present disclosure and are used to explain the principles of the disclosure.

FIG. 1 shows a flowchart of a data processing method according to an embodiment of the present disclosure.

FIG. 2 shows a schematic diagram of a data storage space according to an embodiment of the present disclosure.

FIG. 3 shows a block diagram of a data processing apparatus according to an embodiment of the present disclosure.

FIG. 4 shows a block diagram of a board card according to an embodiment of the present disclosure.

### DETAILED DESCRIPTIONS

Various exemplary embodiments, features, and aspects of the present disclosure will be described in detail below with reference to the drawings. The same labels in the drawings represent the same or similar elements. Although various aspects of the embodiments are shown in the drawings, the drawings are not necessarily drawn to scale unless specifically noted.

In addition, various specific details are provided for better illustration and description of the present disclosure. Those skilled in the art should understand that the present disclosure can be implemented without certain specific details. In some embodiments, methods, means, components, and circuits that are well known to those skilled in the art have not been described in detail in order to highlight the main idea of the present disclosure.

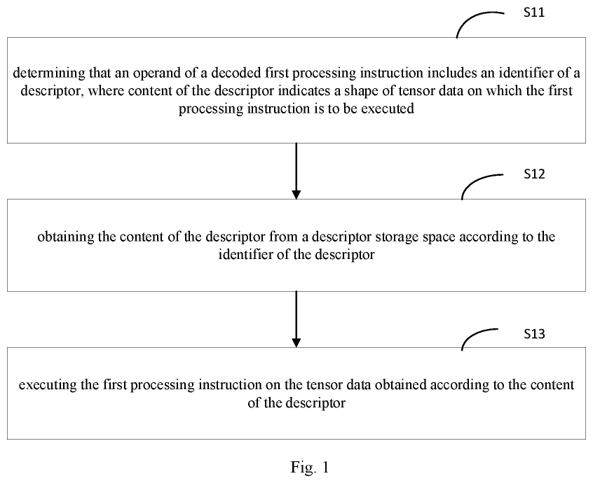

One aspect of the present disclosure provides a data processing method. FIG. 1 shows a flowchart of a data processing method according to an embodiment of the present disclosure. As shown in FIG. 1 the data processing method includes:

a step S11: determining that an operand of a decoded first processing instruction includes an identifier of a descriptor, where content of the descriptor indicates a shape of tensor data on which the first processing instruction is to be executed;

a step S12: obtaining the content of the descriptor from a descriptor storage space according to the identifier of the descriptor; and

a step S13: executing the first processing instruction on the tensor data obtained according to the content of the descriptor.

According to embodiments of the present disclosure, by introducing a descriptor indicating the shape of a tensor, the corresponding content of the descriptor can be determined when the identifier of the descriptor is included in the operand of a decoded processing instruction, and the processing instruction can be executed according to the content of the descriptor, which can reduce the complexity of data access and improve the efficiency of data access.

For example, the data processing method can be applied to a processor, where the processor may include a general-purpose processor (such as a CPU (central processing unit), a GPU (graphics processor)) and a dedicated processor (such as an AI processor, a scientific computing processor, or a digital signal processor, etc.). This disclosure does not limit the type of the processor to which the disclosed methods can be applied.

In some embodiments, data to be processed may include N-dimensional tensor data (N is an integer greater than or equal to 0, for example, N=1, 2, or 3). The tensor may have various forms of data structure. In some embodiments, the tensor may have different dimensions, for example, a scalar can be viewed as a 0-dimensional tensor, a vector can be viewed as a one-dimensional tensor, and a matrix can be a tensor of two or more dimensions. Consistent with the present disclosure, the “shape” of a tensor indicates dimensions of the tensor and a size of each dimension and the like. For example, the shape of a tensor:

$$[ \begin{matrix}1 & 2 & 3 & 4 \\ 11 & 22 & 33 & 44\end{matrix} ] ,$$

can be described by the descriptor as (2, 4). In other words, the shape of this 2-dimensional tensor is described by two parameters: the first parameter 2 corresponds to the size of a first dimension (column), and the second parameter 4 corresponds to the size of a second dimension (row). It should be noted that the present disclosure does not limit the manner in which the descriptor indicates the shape of the tensor.

Conventionally, a processing instruction usually includes one or more operands and each operand includes the data address of data on which the processing instruction is to be executed. The data can be tensor data or scalar data. However, the data address only indicates the storage area in a memory where the tensor data is stored. It neither indicates the shape of the tensor data, nor identifies the related information such as the relationship between this tensor data and other tensor data. As a result, the processor is inefficient in accessing tensor data. In the present disclosure, a descriptor (tensor descriptor) is introduced to indicate the shape of the tensor (N-dimensional tensor data), where the value of N can be determined according to a count of dimensions (orders) of the tensor data, and can also be set according to the usage of the tensor data. For example, when the value of N is 3, the tensor data is 3-dimensional tensor data, and the descriptor can be used to indicate the shape (such as offset, size, etc.) of the 3-dimensional tensor data in three dimensions. It should be understood that those skilled in the art can set the value of N according to actual needs, which is not limited in the present disclosure.

In some embodiments, the descriptor may include an identifier and content. The identifier of the descriptor may be used to distinguish the descriptor from other descriptors. For example, the identifier may be an index. The content of the descriptor may include at least one shape parameter (such as a size of each dimension of the tensor, etc.) representing the shape of the tensor data, and may also include at least one address parameter (such as a base address of a datum point) representing an address of the tensor data. The present disclosure does not limit the specific parameters included in the content of the descriptor.

By using the descriptor to describe the tensor data, the shape of the tensor data can be indicated, and related information such as the relationship among a plurality of pieces of tensor data can be determined accordingly, thus improving the efficiency of accessing tensor data.

In some embodiments, when a processing instruction is received, the processing instruction can be decoded first. The data processing method further includes: decoding the received first processing instruction to obtain a decoded first processing instruction. The decoded first processing instruction includes an operation code and one or more operands, where the operation code is used to indicate a type of processing contemplated by the first processing instruction.

In this case, after the first processing instruction is decoded, the decoded first processing instruction (microinstruction) can be obtained. The first processing instruction may include a data access instruction, an operation instruction, a descriptor management instruction, a synchronization instruction, and the like. The present disclosure does not limit the specific type of the first processing instruction and the specific manner of decoding.

The decoded first processing instruction includes an operation code and one or more operands, where the operation code is used to indicate a processing type corresponding to the first processing instruction, and the operand is used to indicate data to be processed. For example, the instruction can be represented as: Add; A; B, where Add is an operation code, A and B are operands, and the instruction is used to add A and B. The present disclosure does not limit a number of operands involved in the operation and formality of the decoded instruction.

In some embodiments, if the operand of the decoded first processing instruction includes the identifier of the descriptor, a storage space in which the descriptor is stored can be determined according to the identifier of the descriptor; and the content (including information indicating the shape, the address, etc., of tensor data) of the descriptor can be obtained from the descriptor storage space; and then the first processing instruction can be executed according to the content of the descriptor.

In some embodiments, the step S12a may include:

determining a data address of the data called for by the operand of the first processing instruction in a data storage space according to the content of the descriptor; and

reading the data from the data address and performing data processing corresponding to the first processing instruction using the data.

For example, according to the content of the descriptor, the data address of the data called for by the operand of the identifier of the descriptor in the first processing instruction in the data storage space may be computed, and then a corresponding processing can be executed according to the data address. For example, for the instruction Add; A; B, if operands A and B include a descriptor identifier TR1 and a descriptor identifier TR2, respectively, the processor may determine descriptor storage spaces according to the identifiers TR1 and TR2, respectively. The processor may then read the content (such as a shape parameter and an address parameter) stored in the respective descriptor storage spaces. According to the content of the descriptors, the data addresses of data A and B can be computed. For example, a data address 1 of A in a memory is ADDR64-ADDR127, and a data address 2 of B in the memory is ADDR1023-ADDR1087. Then, the processor can read data from the address 1 and the address 2 respectively, execute an addition (Add) operation, and obtain an operation result (A+B).

In some embodiments, the method according to the embodiment of the present disclosure may be implemented by a hardware structure, e.g., a processor. In some embodiments, the processor may include a control unit and an execution unit. The control unit is used for control, for example, the control unit may read an instruction of a memory or an externally input instruction, decode the instruction, and send a micro-operation control signal to corresponding components. The execution unit is configured to execute a specific instruction, where the execution unit may be, for example, an ALU (arithmetic and logic unit), an MAU (memory access unit), an NFU (neural functional unit), etc. The present disclosure does not limit the specific hardware type of the execution unit.

In some embodiments, the instruction can be decoded by the control unit to obtain the decoded first processing instruction. It is then determined whether the decoded first processing instruction includes an identifier of the descriptor. If the operand of the decoded first processing instruction includes the identifier of the descriptor, the control unit may determine the descriptor storage space corresponding to the descriptor and obtain the content (shape, address, etc.) of the descriptor from the descriptor storage space. Then, the control unit may send the content of the descriptor and the first processing instruction to the execution unit, so that the execution unit can execute the first processing instruction according to the content of the descriptor. When the content of the descriptor and the first processing instruction are received by the execution unit, the execution unit may compute the data address at which the data of each operand is stored in the data storage space according to the content of the descriptor. The execution unit then obtains the data from the data addresses and perform a computation on the operand data according to the first processing instruction.

For example, for the instruction Add; A; B, if operands A and B include the identifier TR1 and the identifier TR2 of the descriptor, respectively, the control unit may determine the descriptor storage spaces corresponding to TR1 and TR2 respectively, and the control unit may read the content (such as a shape parameter and an address parameter) of the descriptor storage spaces and send the content to the execution unit. After receiving the content of the descriptor, the execution unit may compute the data addresses of data A and B, for example, a data address 1 of A in a memory is ADDR64-ADDR127, and a data address 2 of B in the memory is ADDR1023-ADDR1087. And then, the execution unit can read data A and B from address 1 and address 2 respectively, execute an addition (Add) operation on A and B, and obtain an operation result (A+B).

In some embodiments, a tensor control module can be provided in the control unit to implement operations associated with the descriptor, where the operations may include registration, modification, and release of the descriptor; reading and writing of the content of the descriptor, etc. The tensor control module may be, for example, a TIU (Tensor interface Unit). The present disclosure does not limit the specific hardware structure of the tensor control module. In this way, the operations associated with the descriptor can be implemented by special hardware, which further improves the access efficiency of tensor data.

In this case, if the operand of the first processing instruction decoded by the control unit includes the identifier of the descriptor, the descriptor storage space corresponding to the descriptor may be determined by the tensor control module. After the descriptor storage space is determined, the content (shape, address, etc.) of the descriptor can be obtained from the descriptor storage space. And then, the control unit may send the content of the descriptor and the first processing instruction to the execution unit, so that the execution unit can execute the first processing instruction according to the content of the descriptor.

In some embodiments, the tensor control module can implement operations associated with the descriptor and the execution of instructions, where the operations may include registration, modification, and release of the descriptor, reading and writing of the content of the descriptor, computation of the data address, and execution of the data access instruction, etc. In this case, if the operand of the first processing instruction decoded by the control unit includes the identifier of the descriptor, the descriptor storage space may be determined by the tensor control module. After the descriptor storage space is determined, the content of the descriptor can be obtained from the descriptor storage space. According to the content of the descriptor, the data address in the data storage space storing the operand data of the first processing instruction is determined by the tensor control module. According to the data address, the data processing corresponding to the first processing instruction is executed by the tensor control module.

The present disclosure does not limit the specific hardware structure adopted for implementing the method provided by the embodiments of the present disclosure.

By adopting the above-mentioned method provided by the present disclosure, the content of the descriptor can be obtained from the descriptor storage space, and then the data address can be obtained. In this way, it is not necessary to input the address through an instruction during each data access, thus improving the data access efficiency of the processor.

In some embodiments, the identifier and content of the descriptor can be stored in the descriptor storage space, where the descriptor storage space can be a storage space in an internal memory (such as a register, an on-chip SRAM, or other medium cache, etc.) of the control unit. Similarly, the data storage space of the tensor data indicated by the descriptor may also be a storage space in the internal memory (such as an on-chip cache) of the control unit or a storage space in an external memory (an off-chip memory) connected to the control unit. The data address of the data storage space may be an actual physical address or a virtual address. The present disclosure does not limit a position of the descriptor storage space and a position of the data storage space, and the type of the data address.

In some embodiments, the identifier of a descriptor, the content of the that descriptor, and the tensor data indicated by that descriptor can be located close to each other in the memory. For example, a continuous area of an on-chip cache with addresses ADDR0-ADDR1023 can be used to store the above information, where an. Within that area, storage spaces with addresses ADDR0-ADDR31 can be used to store the identifier of the descriptor, storage spaces with addresses ADDR32-ADDR63 can be used to store the content of the descriptor, and storage spaces with addresses ADDR64-ADDR1023 can be used to store the tensor data indicated by the descriptor. The address ADDR is not limited to 1 bit or 1 byte, and the ADDR is an address unit used to represent an address. Those skilled in the art can determine the storage area and the address thereof according to the specific applications, which is not limited in the present disclosure.

In some embodiments, the identifier, content of the descriptor and the tensor data indicated by the descriptor can be stored in different areas of the memory distant from each other. For example, a register of the memory can be used as the descriptor storage space to store the identifier and content of the descriptor, and an on-chip cache can be used as the data storage space to store the tensor data indicated by the descriptor.

In some embodiments, a special register (SR) may be provided for the descriptor, where the data in the descriptor may be data preprogramed in the descriptor or can be later obtained from the special register for the descriptor. When the register is used to store the identifier and content of the descriptor, a serial number of the register can be used to indicate the identifier of the descriptor. For example, if the serial number of the register is 0, the identifier of a descriptor stored in the register is 0. When the descriptor is stored in the register, an area can be allocated in a caching space (such as creating a tensor cache unit for each tensor data in the cache) according to the size of the tensor data indicated by the descriptor for storing the tensor data. It should be understood that a caching space of a predetermined size may also be used to store the tensor data, which is not limited in the present disclosure.

In some embodiments, the identifier and content of the descriptor can be stored in an internal memory, and the tensor data indicated by the descriptor can be stored in an external memory. For example, on-chip storage of the identifier and content of the descriptor and off-chip storage of the tensor data indicated by the descriptor may be adopted.

In some embodiments, the data address of the data storage space identified by the descriptor may be a fixed address. For example, a separate data storage space may be designated for each tensor data, where start address of each tensor data in the data storage space is identified by the identifier of the descriptor. In this case, the execution unit can determine the data address of the data corresponding to the operand according to the identifier of the descriptor, and then execute the first processing instruction.

In some embodiments, when the data address of the data storage space corresponding to the identifier of the descriptor is a variable address, the descriptor may be also used to indicate the address of N-dimensional tensor data, where the content of the descriptor may further include at least one address parameter representing the address of the tensor data. For example, if the tensor data is a 3-dimensional data, when the descriptor points to the address of the tensor data, the content of the descriptor may include an address parameter indicating the address of the tensor data, such as a start address of the tensor data; or the content of the descriptor may include a plurality of address parameters of the address of the tensor data, such as a start address+address offset of the tensor data, or address parameters of the tensor data in each dimension. Those skilled in the art can set the address parameters according to actual needs, which is not limited in the present disclosure.

In some embodiments, the address parameter of the tensor data includes a base address of the datum point of the descriptor in the data storage space of the tensor data, where the base address may be different according to the change of the datum point. The present disclosure does not limit the selection of the datum point.

In some embodiments, the base address may include a start address of the data storage space. When the datum point of the descriptor is a first data block of the data storage space, the base address of the descriptor is the start address of the data storage space. When the datum point of the descriptor is other data than the first data block in the data storage space, the base address of the descriptor is the physical address of the data block in the data storage space.

In some embodiments, the shape parameter of a N-dimensional tensor data includes at least one of the followings: a size of the data storage space of the tensor data in at least one of the N dimensions, a size of the storage area in at least one of the N dimensions, an offset of the storage area in at least one of the N dimensions, a position of at least two vertices at diagonal positions in the N dimensions relative to the datum point, and a mapping relationship between a data description position of the tensor data indicated by the descriptor and the data address of the tensor data indicated by the descriptor. The data description position is a mapping position of a point or an area in the tensor data indicated by the descriptor, for example, if the tensor data is 3-dimensional data, the descriptor can use a coordinate (x, y, z) to represent the shape of the tensor data, and the data description position of the tensor data can be represented by the coordinate (x, y, z), and the data description position of the tensor data may be a position of a point or an area to which the tensor data is mapped in a 3-dimensional space.

It should be understood that those skilled in the art may select a shape parameter representing tensor data according to actual conditions, which is not limited in the present disclosure.

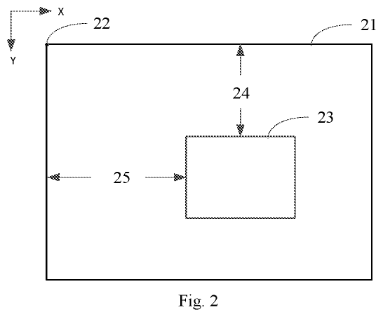

FIG. 2 shows a schematic diagram of a data storage space according to an embodiment of the present disclosure. As shown in FIG. 2, a data storage space 21 stores a 2-dimensional data in a row-first manner, where the data storage space 21 can be represented by (x, y) (where the X axis extends horizontally to the right, and the Y axis extends vertically down), a size in the X axis direction (a size of each row) is ori_x (which is not shown in the figure), a size in the Y axis direction (a total count of rows) is ori_y (which is not shown in the figure), and a start address PA_start (a base address) of the data storage space 21 is a physical address of a first data block 22. A data block 23 is part of the data in the data storage space 21, where an offset 25 of the data block 23 in the X axis direction is represented as offset_x, an offset 24 of the data block 23 in the Y axis direction is represented as offset_y, the size in the X axis direction is denoted by size_x, and the size in the Y axis direction is denoted by size_y.

In some embodiments, when the descriptor is used to define the data block 23, the datum point of the descriptor may be a first data block of the data storage space 21, the base address of the descriptor is the start address PA_start of the data storage space 21, and then the content of the descriptor of the data block 23 may be determined according to the size ori_x of the data storage space 21 in the X axis, the size ori_y of the data storage space 21 in the Y axis, the offset offset_y of the data block 23 in the Y axis direction, the offset offset_x of the data block 23 in the X axis direction, the size size_x of the data block 23 in the X axis direction, and the size size_y of the data block 23 in the Y axis direction.

In some embodiments, the content of the descriptor may be structured as shown by the following formula (1):

$$\{ \begin{matrix}X direction \text{:} ori\_ x , offset\_ x , size\_ x \\ Y direction \text{:} ori\_ y , offset\_ y , size\_ y \\ PA \_start\end{matrix} \qquad ( 1 )$$

It should be understood that although the descriptor describes a 2-dimensional space in the above-mentioned example, those skilled in the art can set the dimensions represented by the content of the descriptor according to actual situations, which is not limited in the present disclosure.

In some embodiments, the content of the descriptor of the tensor data may be determined according to the base address of the datum point of the descriptor in the data storage space and the position of at least two vertices at diagonal positions in N dimensions relative to the datum point.

For example, the content of the descriptor of the data block 23 in FIG. 2 can be determined according to the base address PA_base of the datum point of the descriptor in the data storage space and the position of two vertices at diagonal positions relative to the datum point. First, the datum point of the descriptor and the base address PA_base in the data storage space are determined, for example, a piece of data (for example, a piece of data at position (2, 2)) in the data storage space 21 is selected as a datum point, and a physical address of the selected data in the data storage space is used as the base address PA_base. And then, the positions of at least two vertices at diagonal positions of the data block 23 relative to the datum point are determined, for example, the positions of vertices at diagonal positions from the top left to the bottom right relative to the datum point are used, where the relative position of the top left vertex is (x_min, y_min), and the relative position of the bottom right vertex is (x_max, y_max). And then the content of the descriptor of the data block 23 can be determined according to the base address PA_base, the relative position (x_min, y_min) of the top left vertex, and the relative position (x_max, y_max) of the bottom right vertex.

In some embodiments, the content of the descriptor can be structured as shown by the following formula (2):

$$\{ \begin{matrix}X direction \text{:} x \_min , x \_max \\ Y direction \text{:} y \_min , y \_max \\ PA \_base\end{matrix} \qquad ( 2 )$$

It should be understood that although the top left vertex and the bottom right vertex are used to determine the content of the descriptor in the above-mentioned example, those skilled in the art may set at least two specific vertices according to actual needs, which is not limited in the present disclosure.

In some embodiments, the content of the descriptor of the tensor data can be determined according to the base address of the datum point of the descriptor in the data storage space and a mapping relationship between the data description position of the tensor data indicated by the descriptor and the data address of the tensor data indicated by the descriptor. The mapping relationship between the data description position and the data address can be set according to actual needs. For example, when the tensor data indicated by the descriptor is 3-dimensional spatial data, the function f (x, y, z) can be used to define the mapping relationship between the data description position and the data address.

In some embodiments, the content of the descriptor can also be structured as shown by the following formula (3):

$$\{ \begin{matrix}f ( x , y , z ) \\ PA \_base\end{matrix} \qquad ( 3 )$$

It should be understood that those skilled in the art can set the mapping relationship between the data description position and the data address according to actual situations, which is not limited in the present disclosure.

When the content of the descriptor is structured according to formula (1), for any datum point in the tensor data, the data description position is set to (x_q, y_q), and then the data address PA2_{(x,y)} of the data in the data storage space can be determined using the following formula (4):

PA2_{(x,y)}=PA_start+(offset_y+y_{q}−1)*ori_x+(offset_x+x_{q}) (4).

By adopting the above-mentioned method provided by the present disclosure, the execution unit may compute the data address of the tensor data indicated by the descriptor in the data storage space according to the content of the descriptor, and then execute processing corresponding to the processing instruction according to the address.

In some embodiments, registration, modification and release operations of the descriptor can be performed through management instructions of the descriptor, and corresponding operation codes are set for the management instructions. For example, a descriptor can be registered (created) through a descriptor registration instruction (TRCreat). As another example, various parameters (shape, address, etc.) of the descriptor can be modified through the descriptor modification instruction. As a further example, the descriptor can be released (deleted) through the descriptor release instruction (TRRelease). The present disclosure does not limit the types of the management instructions of the descriptor and the operation codes.

In some embodiments, the data processing method further includes:

when the first processing instruction is a descriptor registration instruction, obtaining a registration parameter of the descriptor in the first processing instruction, wherein the registration parameter includes at least one of the identifier of the descriptor, the shape of the tensor, and the tensor data;

determining a first storage area for the content of the descriptor in the descriptor storage space, and a second storage area for the tensor indicated by the content of the descriptor in the data storage space;

determining the content of the descriptor according to the registration parameter of the descriptor, wherein the content of the descriptor indicates the second storage area; and

storing the content of the descriptor into the first storage area.

For example, the descriptor registration instruction may be used to register a descriptor, and the instruction may include a registration parameter of the descriptor. The registration parameter may include at least one of the identifier (ID) of the descriptor, the shape of the tensor, and the tensor data indicated by the descriptor. For example, the registration parameter may include an identifier TR0 and the shape of the tensor (a count of dimensions, a size of each dimension, an offset, a start data address, etc.). The present disclosure does not limit the specific content of the registration parameter.

In some embodiments, when the instruction is determined to be a descriptor registration instruction according to an operation code of the decoded first processing instruction, the corresponding descriptor can be created according to the registration parameter in the first processing instruction. The corresponding descriptor can be created by a control unit or by a tensor control module, which is not limited in the present disclosure.

In some embodiments, the first storage area of the content of the descriptor in the descriptor storage space and the second storage area of the tensor data indicated by the descriptor in the data storage space may be determined first.

In some embodiments, if at least one of the storage areas has been preset, the first storage area and/or the second storage area may be directly determined. For example, it is preset that the content of the descriptor and the content of the tensor data are stored in a same storage space, and the storage address of the content of the descriptor corresponding to the identifier TR0 of the descriptor is ADDR32-ADDR63, and the storage address of the content of the tensor data is ADDR64-ADDR1023, then the two addresses can be directly determined as the first storage area and the second storage area.

In some embodiments, if there is no preset storage area, the first storage area may be allocated in the descriptor storage space for the content of the descriptor, and the second storage area may be allocated in the data storage space for the content of the tensor data. The storage area may be allocated through the control unit or the tensor control module, which is not limited in the present disclosure.

In some embodiments, according to the shape of the tensor in the registration parameter and the data address of the second storage area, the correspondence between the shape of the tensor and the address can be established to determine the content of the descriptor, so that the corresponding data address can be determined according to the content of the descriptor during data processing. The second storage area can be indicated by the content of the descriptor, and the content of the descriptor can be stored in the first storage area to complete the registration process of the descriptor.

For example, for the tensor data 23 shown in FIG. 2, the registration parameter may include the start address PA_start (base address) of the data storage space 21, an offset 25 (offset_x) in the X-axis direction, and an offset 24 (offset_y) in the Y-axis direction, the size in the X-axis direction (size_x), and the size in the Y-axis direction (as size_y). Based on the parameters, the content of the descriptor can be determined according to formula (1) and stored in the first storage area, thereby completing the registration process of the descriptor.

By adopting the above-mentioned method provided by the present disclosure, the descriptor can be automatically created according to the descriptor registration instruction, and the correspondence between the tensor data indicated by the descriptor and the data address can be realized, so that the data address can be obtained through the content of the descriptor during data processing, and the data access efficiency of the processor can be improved.

In some embodiments, the data processing method further includes:

when the first processing instruction is a descriptor release instruction, obtaining the identifier of the descriptor in the first processing instruction; and

according to the identifier of the descriptor, releasing a first storage area storing the content of descriptor in the descriptor storage space and a second storage area storing the tensor data in the data storage space.

For example, the descriptor release instruction may be used to release (delete) the descriptor in the descriptor storage space to free up the space occupied by the descriptor. The instruction may include at least the identifier of the descriptor.

In some embodiments, when the instruction is determined to be the descriptor release instruction according to the operation code of the decoded first processing instruction, the corresponding descriptor stored at an address indicated by the identifier of the descriptor in the first processing instruction can be released. The corresponding descriptor can be released through the control unit or the tensor control module, which is not limited in the present disclosure.

In some embodiments, according to the identifier of the descriptor, the storage area of the descriptor in the descriptor storage space and/or the storage area of the content of the tensor data in the data storage space indicated by the descriptor can be freed, so that each storage area by the descriptor is released.

By adopting the above-mentioned method provided by the present disclosure, the space occupied by the descriptor can be released after the descriptor is used the limited storage resources can be reused, and the efficiency of resource utilization is improved.

In some embodiments, the data processing method further includes:

when the first processing instruction is a descriptor modification instruction, obtaining a modification parameter of the descriptor in the first processing instruction, wherein the modification parameter includes at least one of the identifier of the descriptor, modified shape of the tensor, and modified tensor data; and

updating the content of the descriptor in the descriptor storage space or the tensor data in the data storage space according to the modification parameter of the descriptor.

For example, the descriptor modification instruction can be used to modify various parameters of the descriptor, such as the identifier, the shape of the tensor, and the like. The descriptor modification instruction may include a modification parameter including at least one of the identifier of the descriptor, a modified shape of the tensor, and the modified tensor data. The present disclosure does not limit the specific content of the modification parameter.

In some embodiments, when the instruction is determined as the descriptor modification instruction according to the operation code of the decoded first processing instruction, the updated content of the descriptor can be determined according to the modification parameter in the first processing instruction. For example, the dimension of a tensor may be changed from 3 dimensions to 2 dimensions, and the size of a tensor in one or more dimension directions may be also changed.

In some embodiments, after the updated content is determined, the content of the descriptor in the descriptor storage space and/or the tensor data in the data storage space may be updated in order to modify the tensor data and change the content of the descriptor to indicate the shape of the modified tensor data. The present disclosure does not limit the scope of the content to be updated and the specific updating method.

By adopting the above-mentioned method provided by the present disclosure, when the tensor data indicated by the descriptor changes, the descriptor is directly modified to maintain the correspondence between the descriptor and the tensor data, which improves the efficiency of resource utilization.

In some embodiments, the data processing method further includes:

according to the identifier of the descriptor, determining whether there is a second processing instruction that has not been executed completely, wherein the second processing instruction is prior to the first processing instruction in an instruction queue and includes the identifier of the descriptor in the operand; and

blocking or caching the first processing instruction when there is the second processing instruction that has not been executed completely.

For example, the descriptor may indicate the dependency between instructions can be determined according to the descriptor. In some embodiments, a dependency between two instructions may indicate relative execution order of the instructions. For example, if instruction A dependents from instruction B, instruction B has to be executed prior to instruction A. Accordingly, if the operand of the decoded first processing instruction includes the identifier of the descriptor, whether there is an instruction, among pre-instructions of the first processing instruction, that has to be executed before the first processing instruction may be determined. A pre-instruction is an instruction prior to the first processing instruction in an instruction queue.

In some embodiments, if an operand of a pre-instruction has the identifier of the descriptor in the first processing instruction, the pre-instruction has to be executed before the first processing instruction. This is also referred to as the first processing instruction “depends on” the second processing instruction. If the operand of the first processing instruction has identifiers of a plurality of descriptors, one or more pre-instructions may be determined as being depended on by the first processing instruction based on the plurality of descriptors. A dependency determining module may be provided in the control unit to determine the dependency between processing instructions.

In some embodiments, if there is a second processing instruction that has to be executed before the first processing instruction but has not yet been executed completely, the first processing instruction has to be executed after the second processing instruction is executed completely. For example, if the first processing instruction is an operation instruction for the descriptor TR0 and the second processing instruction is a writing instruction for the descriptor TR0, the first processing instruction depends on the second processing instruction. Until the execution of the second processing instruction is completed, the first processing instruction cannot be executed. For another example, if the second processing instruction includes a synchronization instruction (sync) for the first processing instruction, the first processing instruction again depends on the second processing instruction, and thus the first processing has to be executed after the second processing instruction is executed completely.

In some embodiments, if there is a second processing instruction that has not been executed completely, the first processing instruction can be blocked, in other words, the execution of the first processing instruction and other instructions after the first processing instruction can be suspended until the second processing instruction is executed completely, and then the first processing instruction and other instructions after the first processing instruction can be executed.

In some embodiments, if there is a second processing instruction that has not been executed completely, the first processing instruction will be cached, in other words, the first processing instruction is stored in a preset caching space without affecting the execution of other instructions. After the execution of the second processing instruction is completed, the first processing instruction in the caching space is then executed. The present disclosure does not limit the particular method of halting the first processing instruction when there is a second processing instruction that has not been executed completely.

By adopting the above-mentioned method provided by the present disclosure, a dependency between instructions caused by the instruction type and/or by the synchronization instruction is determined, and the first processing instruction is blocked or cached when the pre-instructions depended on by the first processing instruction has not been executed completely, thereby ensuring the execution order of the instructions, and the correctness of data processing.

In some embodiments, the data processing method further includes:

determining the current state of the descriptor according to the identifier of the descriptor, where the state of the descriptor includes an operable state or an inoperable state; and

blocking or caching the first processing instruction when the descriptor is in the inoperable state.

For example, a correspondence table for the state of the descriptor (for example, a correspondence table for the state of the descriptor may be stored in a tensor control module) may be set to display the current state of the descriptor, where the state of the descriptor includes the operable state or the inoperable state.

In some embodiments, in the case where the pre-instructions of the first processing instruction are processing the descriptor (for example, writing or reading), the current state of the descriptor may be set to the inoperable state. Under the inoperable state, the first processing instruction cannot be executed, and will be blocked or cached. Conversely, in the case where there is no pre-instruction that is currently processing the descriptor, the current state of the descriptor may be set to the operable state. Under the operable state, the first processing instruction can be executed.

In some embodiments, when the content of the descriptor is stored in a TR (Tensor Register), the usage of TR may be stored in the correspondence table for the state of the descriptor to determine whether the TR is occupied or released, so as to manage limited register resources.

By adopting the above-mentioned method provided by the present disclosure, the dependency between instructions can be determined according to the state of the descriptor, thereby ensuring the execution order of the instructions, and accuracy of data processing.

In some embodiments, the first processing instruction includes a data access instruction, and the operand includes source data and target data. Accordingly, in step S11, it may be determined that at least one of the source data and the target data includes an identifier of a descriptor. In step S12, the content of the descriptor is obtained from the descriptor storage space based on the identifier of the descriptor. In step S13, according to the content of the descriptor, a first data address of the source data and a second data address of the target data are determined respectively, and then data is read from the first data address and written to the second data address.

For example, the operand of the data access instruction includes source data and target data, and the operand of the data access instruction is used to read data from the data address of the source data and write the data to the data address of the target data. When the first processing instruction is a data access instruction, the tensor data can be accessed through the descriptor. When at least one of the source data and the target data of the data access instruction includes the identifier of the descriptor, the descriptor storage space of the descriptor may be determined.

In some embodiments, if the source data includes an identifier of a first descriptor and the target data includes an identifier of a second descriptor, a first descriptor storage space of the first descriptor and a second descriptor storage space of the second descriptor may be determined, respectively. Then the content of the first descriptor and the content of the second descriptor are read from the first descriptor storage space and the second descriptor storage space, respectively. According to the content of the first descriptor and the content of the second descriptor, the first data address of the source data and the second data address of the target data can be computed, respectively. Finally, data is read from the first data address and written to the second data address to complete the entire access process.

For example, the source data may be off-chip data to be read, and the identifier of the first descriptor of the source data is 1. The target data is a piece of storage space on the chip, and the identifier of the second descriptor of the target data is 2. The content D1 of the first descriptor and the content D2 of the second descriptor can be respectively obtained from the descriptor storage space according to the identifier 1 of the first descriptor of the source data and the identifier 2 of the second descriptor of the target data. In some embodiments, the content D1 of the first descriptor and the content D2 of the second descriptor can be structured as follows:

$$D 1 \text{:} \{ \begin{matrix}X direction \text{:} ori\_ x 1 , offset\_ x 1 , size\_ x1 \\ Y direction \text{:} ori\_ y1 , offset\_ y1 , size\_ y1 \\ PA \_start1\end{matrix} \\ D 2 \text{:} \{ \begin{matrix}X direction \text{:} ori\_ x2 , offset\_ x2 , size\_ x2 \\ Y direction \text{:} ori\_ y2 , offset\_ y2 , size\_ y2 \\ PA \_start2\end{matrix}$$

According to the content D1 of the first descriptor and the content D2 of the second descriptor, a start physical address PA3 of the source data and a start physical address PA4 of the target data can be respectively obtained, which can be structured as follows in some embodiments:

PA3=PA_start1+(offset_{y1}−1)*ori_x1+offset_x1

PA4=PA_start2+(offset_{y2}−1)*ori_x2+offset_x2

According to the start physical address PA3 of the source data and the start physical address PA4 of the target data, and the content D1 of the first descriptor and the content D2 of the second descriptor, the first data address and the second data address can be determined, respectively. Data is read from the first data address and written to the second data address (via an IO path). The process of loading the tensor data indicated by D1 into the storage space indicated by D2 is completed.

In some embodiments, if only the source data includes the identifier of the first descriptor, the first descriptor storage space of the first descriptor can be determined. Then the content of the first descriptor is read from the first descriptor storage space. According to the content of the first descriptor, the first data address of the source data can be determined. According to the second data address of the target data in the operand of the instruction, data can be read from the first data address and written to the second data address. The entire access process is then finished.

In some embodiments, if only the target data includes the identifier of the second descriptor, the second descriptor storage space of the second descriptor can be determined. Then the content of the second descriptor is read from the second descriptor storage space. According to the content of the second descriptor, the second data address of the target data can be determined. According to the first data address of the source data in the operand of the instruction, data can be read from the first data address and written to the second data address. The entire access process is then finished.

By adopting the above-mentioned method provided by the present disclosure, the descriptor can be used to complete the data access. In this way, there is no need to provide the data address by the instructions during each data access, thereby improving data access efficiency.

In some embodiments, the first processing instruction includes an operation instruction, the step S13 further includes:

determining a data address of the tensor data in a data storage space according to the content of the descriptor;

obtaining the tensor data from the data address in the data storage space; and

executing an operation on the tensor data according to the first processing instruction.

For example, when the first processing instruction is an operation instruction, the operation of tensor data can be implemented via the descriptor. When the operand of the operation instruction includes the identifier of the descriptor, the descriptor storage space of the descriptor can be determined. Then the content of the descriptor is read from the descriptor storage space. According to the content of the descriptor, the data address corresponding to the operand can be determined, and then data is read from the data address to execute operations. The entire operation process then concludes. By adopting the above-mentioned method, the descriptor can be used to read data during operations, and there is no need to provide the data address by instructions, thereby improving data operation efficiency.

According to the data processing method provided in the embodiments of the present disclosure, the descriptor indicating the shape of the tensor is introduced, so that the data address can be determined via the descriptor during the execution of the data processing instruction. The instruction generation method is simplified from the hardware side, thereby reducing the complexity of data access and improving the data access efficiency of the processor.

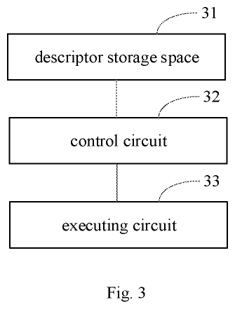

FIG. 3 shows a block diagram of a data processing apparatus according to an embodiment of the present disclosure. As shown in FIG. 3, the present disclosure further provides a data processing apparatus including: a descriptor storage space 31 and a control circuit 32 configured to determine that an operand of a first processing instruction includes an identifier of a descriptor, where content of the descriptor indicates a shape of tensor data on which the first processing instruction is to be executed. The control circuit 32 is further configured to obtain the content of the descriptor according the identifier of the descriptor. The content of the descriptor indicates a shape of a tensor. The data processing apparatus further includes an executing circuit 33 configured to execute the first processing instruction on the tensor data obtained according to the content of the descriptor.

In some embodiments, the descriptor storage space 31 may be any suitable magnetic storage medium or magneto-optical storage medium configured to store the content of the descriptor, such as RRAM (Resistive Random Access Memory), Dynamic Random Access Memory (DRAM), and Static Random Access Memory SRAM (Static Random-Access Memory), Enhanced Dynamic Random Access Memory (EDRAM), High-Bandwidth Memory (HBM), Hybrid Memory Cube (HMC), etc.

In some embodiments, each of the control circuit 32 and executing circuit 33 may be a digital circuit, an analog circuit, etc. The physical realization of the hardware structure includes but is not limited to transistors, memristors, and the like. Each of circuit 32 and 33 may include multiple modules and submodules configured to perform various functions of the data processing apparatus.

In some embodiments, the executing circuit includes: an address determining sub-module configured to determine a data address of the data corresponding to an operand of the first processing instruction in the data storage space according to the content of the descriptor; and a data processing sub-module configured to execute data processing corresponding to the first processing instruction according to the data address.

In some embodiments, the control circuit 32 further includes: a first parameter obtaining module configured to obtain a registration parameter of the descriptor in the first processing instruction when the first processing instruction is a descriptor registration instruction, where the registration parameter includes at least one of the identifier of the descriptor, the shape of the tensor, and the content of the tensor data indicated by the descriptor; an area determining module configured to determine a first storage area of the content of the descriptor in the descriptor storage space according to the registration parameter of the descriptor, and to determine a second storage area of the content of the tensor data indicated by the descriptor in the data storage space; a content determining module configured to determine the content of the descriptor according to the registration parameter of the descriptor and the second storage area to establish a correspondence between the descriptor and the second storage area; and a content storage module configured to store the content of the descriptor in the first storage area.

In some embodiments, the processing circuit further includes: an identifier obtaining module configured to obtain an identifier of the descriptor in the first processing instruction when the first processing instruction is a descriptor release instruction; and a space release module configured to respectively release the storage area of the descriptor in the descriptor storage space and the storage area of the content of the tensor data indicated by the descriptor in the data storage space according to the identifier of the descriptor.

In some embodiments, the processing circuit further includes: a second parameter obtaining module configured to obtain a modification parameter of the descriptor in the first processing instruction when the first processing instruction is a descriptor modification instruction, where the modification parameter includes at least one of the identifier of the descriptor, the shape of the tensor to be modified, and the content of the tensor data indicated by the descriptor; a content to be updated determining module configured to determine the content of the descriptor to be updated according to the modification parameter of the descriptor; and a content updating module configured to update the content of the descriptor in the descriptor storage space and/or the content of tensor data in the data storage space according to the content to be updated.

In some embodiments, the processing circuit further includes: an instruction determining module configured to determine whether there is a second processing instruction that has not been executed completely according to the identifier of the descriptor, where the second processing instruction includes processing instructions in the instruction queue prior to the first processing instruction and having the identifier of the descriptor in the operand; and a first instruction caching module configured to block or cache the first processing instruction when there is a second processing instruction that has not been executed completely.

In some embodiments, the processing circuit further includes: a state determining module configured to determine the current state of the descriptor according to the identifier of the descriptor, where the state of the descriptor includes the operable state or the inoperable state; and a second instruction caching module configured to block or cache the first processing instruction when the descriptor is in the inoperable state.

In some embodiments, the first processing instruction includes a data access instruction, and the operand includes source data and target data. The content obtaining module includes a content obtaining sub-module configured to obtain the content of the descriptor from the descriptor storage space when at least one of the source data and the target data includes the identifier of the descriptor. The instruction executing module includes a first address determining sub-module configured to determine the first data address of the source data and/or the second data address of the target data, respectively, according to the content of the descriptor; and an access sub-module configured to read data from the first data address and write the data to the second data address.

In some embodiments, the first processing instruction includes an operation instruction. The instruction executing module includes: a second address determining sub-module configured to determine the data address of the data corresponding to the operand of the first processing instruction in the data storage space according to the content of the descriptor; and an operation sub-module configured to execute an operation corresponding to the first processing instruction according to the data address.

In some embodiments, the descriptor is used to indicate the shape of N-dimensional tensor data, where N is an integer greater than or equal to 0. The content of the descriptor includes at least one shape parameter indicating the shape of the tensor data.

In some embodiments, the descriptor is also used to indicate the address of N-dimensional tensor data. The content of the descriptor further includes at least one address parameter indicating the address of the tensor data.

In some embodiments, the address parameter of the tensor data includes the base address of the datum point of the descriptor in the data storage space of the tensor data. The shape parameter of the tensor data includes at least one of the followings: a size of the data storage space in at least one of N dimensions, a size of the storage area of the tensor data in at least one of N dimensions, an offset of the storage area in at least one of N dimensions, a position of at least two vertices at diagonal positions in N dimensions relative to the datum point, and a mapping relationship between a data description position of the tensor data indicated by the descriptor and the data address of the tensor data indicated by the descriptor.

In some embodiments, the control circuit 32 is further configured to decode the received first processing instruction to obtain a decoded first processing instruction, where the decoded first processing instruction includes an operation code and one or more operands, and the operation code is used to indicate a processing type corresponding to the first processing instruction.

In some embodiments, the present disclosure further provides a neural network chip including the data processing apparatus. A set of neural network chips is used to support various deep learning and machine learning algorithms to meet the intelligent processing needs of complex scenarios in computer vision, speech, natural language processing, data mining and other fields. The neural network chip includes neural network processors, where the neural network processors may be any appropriate hardware processor, such as CPU (Central Processing Unit), GPU (Graphics Processing Unit), FPGA (Field-Programmable Gate Array), DSP (Digital Signal Processor), ASIC (Application Specific Integrated Circuit), and the like.

In some embodiments, the present disclosure provides a board card including a storage device, an interface apparatus, a control device, and the above-mentioned neural network chip. on the board card, the neural network chip is connected to the storage device, the control device, and the interface apparatus, respectively; the storage device is configured to store data; the interface apparatus is configured to implement data transmission between the neural network chip and an external device; and the control device is configured to monitor the state of the neural network chip.

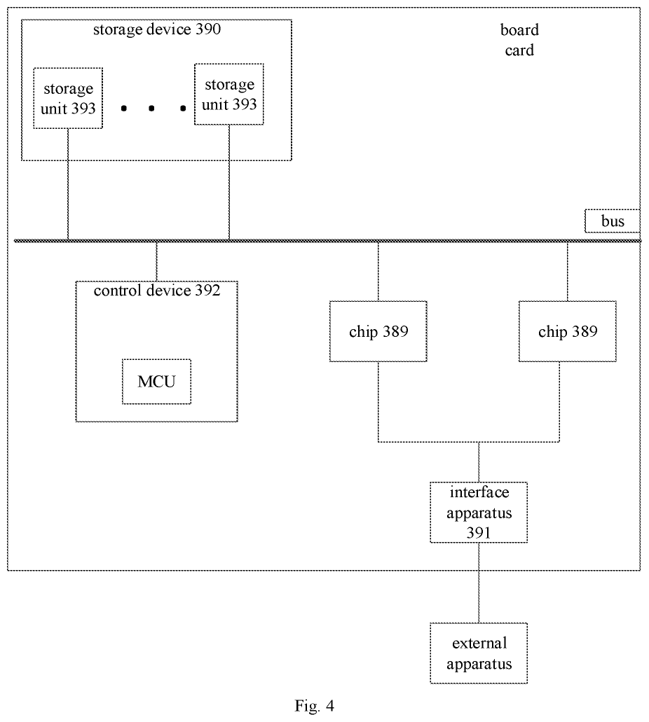

FIG. 4 shows a block diagram of a board card according to an embodiment of the present disclosure. As shown in FIG. 4, in addition to the above-mentioned chip 389, the board card may further include other components, including but not limited to: a storage device 390, an interface apparatus 391, and a control device 392.

The storage device 390 is connected to the neural network chip through a bus, and is configured to store data. The storage device 390 may include a plurality of groups of storage units 393, where each group of the storage units is connected with the neural network chip by the bus. The descriptor storage space and data storage space described in this disclosure may be part of the storage device 390. It can be understood that each group of the storage units may be DDR SDRAM (Double Data Rate Synchronized Dynamic Random Access Memory)).

DDR can double a speed of SDRAM without increasing a clock rate. DDR allows reading data on rising and falling edges of the clock pulse. DDR is twice as fast as standard SDRAM. In an embodiment, the storage device may include 4 groups of the storage unit, where each group of the storage units may include a plurality of DDR4 particles (chips). In an embodiment, the inner part of the neural network chip may include four 72-bit DDR4 controllers, in which 64 bits of the four 72-bit DDR4 controllers are used for data transmission, and 8 bits of the four 72-bit DDR4 controllers are used for ECC check. It can be understood that when DDR4-3200 particles are used in each group of the storage units, the theoretical bandwidth of data transmission can reach 25600 MB/s.

In an embodiment, each group of the storage units may include a plurality of DDR SDRAMs arranged in parallel. DDR can transmit data twice in one clock cycle. A controller for controlling DDR is provided in the chip, where the controller is used for controlling the data transmission and data storage of each storage unit.

The interface apparatus is electrically connected to the neural network chip, where the interface apparatus is configured to implement data transmission between the neural network chip and an external device (such as a server or a computer). For example, in an embodiment, the interface apparatus may be a standard PCIE interface, and data to be processed is transmitted from the server to the chip through the standard PCIE interface to realize data transmission. Preferably, when a PCIE 3.0×16 interface is used for data transmission, the theoretical bandwidth can reach 16000 MB/s. In another embodiment, the interface apparatus may further include other interfaces. The present disclosure does not limit the specific types of the interfaces, as long as the interface units can implement data transmission. In addition, the computation result of the neural network chip is still transmitted back to an external device (such as a server) by the interface apparatus.

The control device is electrically connected to the neural network chip, where the control device is configured to monitor the state of the neural network chip. Specifically, the neural network chip may be electrically connected to the control device through an SPI interface, where the control device may include an MCU (Micro Controller Unit). The neural network chip may include a plurality of processing chips, a plurality of processing cores, or a plurality of processing circuits, and is capable of driving a plurality of loads. Therefore, the neural network chip can be in different working state such as multi-load state and light-load state. The operations of a plurality of processing chips, a plurality of processing cores and or a plurality of processing circuits in the neural network chip can be regulated by the control device.

In some embodiments, the present disclosure provides an electronic device including the neural network chip. The electronic device includes a data processing apparatus, a robot, a computer, a printer, a scanner, a tablet computer, an intelligent terminal, a mobile phone, an automobile data recorder, a navigator, a sensor, a webcam, a cloud server, a camera, a video camera, a projector, a watch, an earphone, a mobile storage, a wearable apparatus, a transportation means, a household electrical appliance, and/or a medical apparatus.

The transportation means may include an airplane, a ship, and/or a vehicle. The household electrical appliance may include a television, an air conditioner, a microwave oven, a refrigerator, an electric rice cooker, a humidifier, a washing machine, an electric lamp, a gas cooker, and a range hood. The medical apparatus may include a nuclear magnetic resonance spectrometer, a B-ultrasonic scanner, and/or an electrocardiograph.

The embodiments of the present disclosure have been described above, and the above description is exemplary, not exhaustive, and is not limited to the disclosed embodiments. Without departing from the scope and spirit of the described embodiments, many modifications and changes are obvious to those ordinary skilled in the art. The choice of terms used herein is intended to best explain the principles, practical applications, or improvements to technologies in the market of the embodiments, or to enable other ordinary skilled in the art to understand the embodiments disclosed herein.

What is claimed is:

1. A data processing method performed by one or more circuits, comprising:
determining that an operand of a first processing instruction includes an identifier of a descriptor, wherein content of the descriptor indicates a shape of tensor data on which the first processing instruction is to be executed;
obtaining the content of the descriptor from a descriptor storage space according to the identifier of the descriptor; and
executing the first processing instruction on the tensor data obtained according to the content of the descriptor.

2. The data processing method of claim 1, wherein the obtaining the content of the descriptor from the descriptor storage space according to the identifier of the descriptor includes:
determining a descriptor address of the content of the descriptor in the descriptor storage space according to the identifier of the descriptor; and
obtaining the content of the descriptor from the descriptor address in the descriptor storage space.

3. The data processing method of claim 1, wherein the executing the first processing instruction on the tensor data obtained according to the content of the descriptor includes:
determining a data address of the tensor data in a data storage space according to the content of the descriptor; and
obtaining the tensor data from the data address in the data storage space.

4. The data processing method of claim 3, further comprising:
when the first processing instruction is a descriptor registration instruction, obtaining a registration parameter of the descriptor in the first processing instruction, wherein the registration parameter includes at least one of the identifier of the descriptor, the shape of the tensor, and the tensor data,
determining a first storage area for the content of the descriptor in the descriptor storage space, and a second storage area for the tensor indicated by the content of the descriptor in the data storage space;
determining the content of the descriptor according to the registration parameter of the descriptor, wherein the content of the descriptor indicates the second storage area; and
storing the content of the descriptor into the first storage area.

5. The data processing method of claim 3, further comprising:
when the first processing instruction is a descriptor release instruction, obtaining the identifier of the descriptor in the first processing instruction; and
according to the identifier of the descriptor, releasing a first storage area storing the content of descriptor in the descriptor storage space and a second storage area storing the tensor data in the data storage space.

6. The data processing method of claim 3, further comprising:
when the first processing instruction is a descriptor modification instruction, obtaining a modification parameter of the descriptor in the first processing instruction, wherein the modification parameter includes at least one of the identifier of the descriptor, modified shape of the tensor, and modified tensor data; and
updating the content of the descriptor in the descriptor storage space or the tensor data in the data storage space according to the modification parameter of the descriptor.

7. The data processing method of claim 1, further comprising:
according to the identifier of the descriptor, determining whether there is a second processing instruction that has not been executed completely, wherein the second processing instruction is prior to the first processing instruction in an instruction queue and includes the identifier of the descriptor in the operand; and
blocking or caching the first processing instruction when there is the second processing instruction that has not been executed completely.

8. The data processing method of claim 1, further comprising:
determining a state of the descriptor according to the identifier of the descriptor; and
blocking or cashing the first processing instruction when the descriptor is an inoperable state.

9. The data processing method of claim 1, wherein the shape of the tensor data includes a count of dimensions of the tensor data and a data size in each dimension.

10. A data processing apparatus, comprising:
a descriptor storage space;
a control circuit configured to:
determine that an operand of a first processing instruction includes an identifier of a descriptor, wherein content of the descriptor indicates a shape of tensor data on which the first processing instruction is to be executed; and
obtain the content of a descriptor from a descriptor storage space according to the identifier of the descriptor; and
an executing circuit configured to execute the first processing instruction on the tensor data obtained according to the content of the descriptor.

11. The data processing apparatus of claim 10, wherein to obtain the content of the descriptor from the descriptor storage space according to the identifier of the descriptor, the control circuit is further configured to:
determine a descriptor address of the content of the descriptor in the descriptor storage space according to the identifier of the descriptor; and
obtain the content of the descriptor from the descriptor address in the descriptor storage space.

12. The data processing apparatus of claim 10, further comprising a data storage space, wherein to execute the first processing instruction on the tensor data obtained according to the content of the descriptor, the executing circuit is further configured to:
determine a data address of the tensor data in the data storage space according to the content of the descriptor; and
obtain the tensor data from the data address in the data storage space.

13. The data processing apparatus of claim 12, the control circuit is further configured to:
when the first processing instruction is a descriptor registration instruction, obtain a registration parameter of the descriptor in the first processing instruction, wherein the registration parameter includes at least one of the identifier of the descriptor, the shape of the tensor, and the tensor data,
determine a first storage area for the content of the descriptor in the descriptor storage space, and a second storage area for the tensor indicated by the content of the descriptor in the data storage space;
determine the content of the descriptor according to the registration parameter of the descriptor, wherein the content of the descriptor indicates the second storage area; and
store the content of the descriptor into the first storage area.

14. The data processing apparatus of claim 12, the control circuit is further configured to:
when the first processing instruction is a descriptor release instruction, obtain the identifier of the descriptor in the first processing instruction; and
according to the identifier of the descriptor, releasing a first storage area storing the content of descriptor in the descriptor storage space and a second storage area storing the tensor data in the data storage space.

15. The data processing apparatus of claim 12, the control circuit is further configured to:
when the first processing instruction is a descriptor modification instruction, obtain a modification parameter of the descriptor in the first processing instruction, wherein the modification parameter includes at least one of the identifier of the descriptor, modified shape of the tensor, and modified tensor data; and
update the content of the descriptor in the descriptor storage space or the tensor data in the data storage space according to the modification parameter of the descriptor.

16. The data processing apparatus of claim 10, the control circuit is further configured to:
according to the identifier of the descriptor, determine whether there is a second processing instruction that has not been executed completely, wherein the second processing instruction is prior to the first processing instruction in an instruction queue and includes the identifier of the descriptor in the operand; and
block or cache the first processing instruction when there is the second processing instruction that has not been executed completely.

17. The data processing apparatus of claim 10, wherein the shape of the tensor data includes a count of dimensions of the tensor data and a data size in each dimension.

18. A neural network chip comprising the data processing apparatus of claim 8.

19. An electronic device comprising the neural network chip of claim 19.

20. A board card comprising a storage device, an interface apparatus, a control device, and the neural network chip of claim 19, wherein
the neural network chip is connected to the storage device, the control device, and the interface apparatus, respectively;
the storage device is configured to store data;
the interface apparatus is configured to implement data transmission between the neural network chip and an external device; and
the control device is configured to monitor a state of the neural network chip.
